(19) United States
(12) Patent Application Publication
(10) Pub. No.: US 2009/0251065 A1
(43) Pub. Date: Oct. 8, 2009

(54) Circuit Arrangement and Method for Operating at Least One LED

(75) Inventors: Peter Niedermeier, München (DE); Bernd Rudolph, Forstern (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRANKTER HAFTUNG, Munchen (DE)

(21) Appl. No.: 12/086,012

(22) PCT Filed: Nov. 29, 2006
(86) PCT No.: PCT/EP2006/069028

§ 371 Date: Jun. 4, 2008

(30) Foreign Application Priority Data
Dec. 7, 2005 (DE) 10 2005 058 484.5

(51) Int. Cl. H05B 41/36

(52) U.S. Cl. 315/291

(57) ABSTRACT

A method and a circuit arrangement for operating at least one LED, includes: a first and a second mains connection for connecting a mains voltage; a first rectifier, whose rectifier input is coupled to the mains connections and at whose rectifier output the rectified mains voltage can be provided; an electronic pump switch coupled to the rectifier output, defining a pump node; a main energy store coupled to that side of the electronic pump switch which faces away from the rectifier output; an inverter coupled to the main energy store supplied with energy therefrom. The inverter provides an inverter voltage at its inverter output which has an inverter frequency; a pump network coupling the inverter output to the pump node; a matching network, via which coupling the inverter output to the connection terminals for at least one LED, wherein the matching network has a resonant circuit having a natural frequency.

### TECHNICAL FIELD

The present invention relates to a circuit arrangement and a method for operating at least one LED (Light Emitting Diode).

### PRIOR ART

LEDs are increasingly making inroads into general lighting on account of their advantages. Cost-effective operating circuits are desired in this context. So-called SELV (Safety Extra Low Voltage) power supplies have been used hitherto, which provide a safety extra low voltage that is potential-isolated from the mains for the supply of the LEDs. In this case, the prior art expends a huge outlay in terms of circuitry in order to ensure the functions of power factor correction, potential isolation, control of the output voltage or of the output current, and protective measures against overload and short circuit.

### SUMMARY OF THE INVENTION

The object of the present invention is to provide a circuit arrangement and a method of operating at least one LED which enable a plurality of the abovementioned functions to be implemented with the least possible outlay in terms of circuitry.

This object is achieved by means of a circuit arrangement having the features of patent claim 1 and also by means of an operating method having the features of patent claim 10.

The present invention is based on the insight that the above object can be achieved by means of a circuit arrangement comprising an inverter, which operates the at least one LED via a matching network with a resonant circuit, wherein the inverter is corrected with regard to the power factor and the mains current harmonics by means of a pump circuit.

If the main energy store were charged directly from the first rectifier, then charging current spikes would arise which would lead to a contravention of the relevant specifications, e.g. IEC 1000-3-2.

The topology of a charge pump comprises the coupling of the rectifier to the main energy store via an electronic pump switch. As a result, a pump node arises between the rectifier and the electronic pump switch. The pump node is coupled to the inverter output via a pump network. The pump network can contain components which can simultaneously be assigned to the matching network. The principle of the charge pump consists in the fact that during one half-cycle of the inverter frequency, energy is drawn from the mains voltage via the pump node and is buffer-stored in the pump network. In the subsequent half-cycle of the inverter frequency, the buffer-stored energy is fed to the main energy store via the electronic pump switch.

Energy is accordingly drawn from the mains voltage with the turning of the inverter frequency. The spectral components of the mains current which are at the inverter frequency or lie above the latter can be suppressed by filter circuits. The charge pump can thus be designed such that the harmonics of the mains current are so small that said specifications are complied with.

One preferred embodiment is distinguished by the fact that it comprises a second rectifier, in particular a full-bridge rectifier, which is coupled between the matching network and the connection terminals for the at least one LED. This measure ensures that the entire energy provided by the matching network is made available to the at least one LED in a form, i.e. with a current direction, in which it can be converted into light by the LED. This measure therefore leads to a high efficiency of a circuit arrangement according to the invention.

Preferably, the circuit arrangement furthermore has at least one coupling capacitor, and the matching network comprises an LC series resonant circuit, wherein the rectifier input of the second rectifier is coupled to the high point of the LC series resonant circuit, on the one hand, and to the at least one coupling capacitor, on the other hand. At least one coupling capacitor in series with the inductance of the LC series resonant circuit prevents a DC current through said inductance and thus the latter's magnetic saturation and effectiveness as a current-limiting element. The voltage swing at the input of the second rectifier in relation to the voltage present at the inverter determines the quality of the correction of the mains current harmonics.

Preferably, a transformer is coupled between the matching network and the connection terminals for the at least one LED. As a result, potential isolation between the circuit arrangement and the at least one LED can be realized in a simple manner.

In this case, it is particularly preferred if the primary side of the transformer is coupled to the matching network and the secondary side of the transformer is coupled to the connection terminals for the at least one LED, wherein a second rectifier, in particular a full-bridge rectifier, is coupled between the secondary side of the transformer and the connection terminals for the at least one LED.

When a second rectifier is used, it is preferred if an inductance is arranged in series with the rectifier output and with the connection terminals for the at least one LED. This measure reduces the ripple of the current fed to the at least one LED.

One preferred development of a circuit arrangement according to the invention furthermore comprises a controller, at the controller output of which an actuating signal can be provided, wherein the controller output is coupled to the inverter in such a way that the actuating signal influences the inverter frequency. In this case, the controller input is preferably coupled to a device for measuring a quantity that is proportional to the current through the at least one LED. It is thereby possible, in a particularly advantageous manner, for the LED current to be controlled to a predeterminable value, taking account of the load, that is to say the number of LEDs used, the mains voltage and the component tolerances of the entire circuit.

Further advantageous embodiments of the invention emerge from the subclaims.

The preferred embodiments mentioned with regard to a circuit arrangement according to the invention, and their advantages, are correspondingly applicable to the operating method according to the invention.

### BRIEF DESCRIPTION OF THE DRAWING(S)

An exemplary embodiment of a circuit arrangement according to the invention will now be described in more detail below with reference to the accompanying drawings, in which:

FIG. 1 shows a block diagram for a circuit arrangement according to the invention for operating at least one LED;

FIG. 2 shows an exemplary embodiment of a circuit arrangement according to the invention for operating at least one LED; and

FIG. 3 shows the temporal profile of the current Iₘₐᵢₙₛ drawn from the mains and of the current I_{LED} through the one LED in the circuit arrangement in accordance with FIG. 2.

### PREFERRED EMBODIMENT OF THE INVENTION

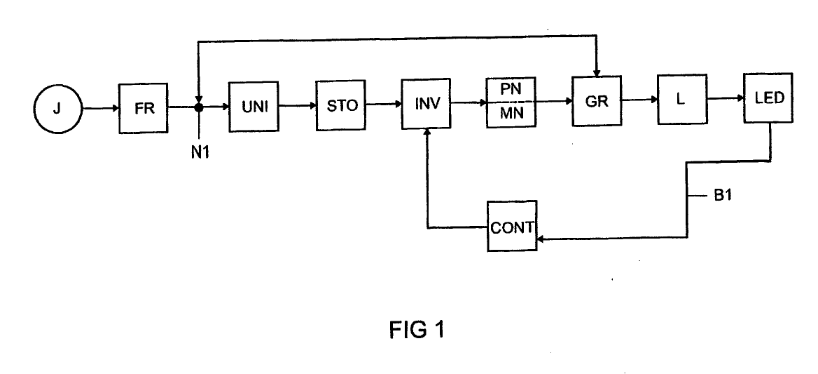

FIG. 1 illustrates a block diagram for a circuit arrangement according to the invention for operating at least one LED. A mains voltage from a mains voltage source can be fed to the circuit arrangement at connection terminals J. The mains voltage is firstly fed into a block FR. On the one hand, said block contains known means for filtering interference and, on the other hand, said block contains a rectifier that rectifies the mains voltage, which is usually an AC voltage but can also be a DC voltage. A bridge-connected full-wave rectifier is usually used for this purpose. The property of the rectifier that it does not permit any current that would mean a flow of energy from the circuit arrangement to the mains voltage source is important for the function of a charge pump realized in the circuit arrangement.

The rectified mains voltage is fed to an electronic pump switch UNI, wherein a pump node N1 arises at the junction point between rectifier FR and electronic pump switch UNI. In the simplest case, the electronic pump switch UNI comprises a pump diode that only allows a current flow that flows from the pump node N1 to the pump diode. However, it is also possible to use any desired electronic switch, such as a MOSFET, for example, for the electronic pump switch UNI which fulfils the function of the pump diode. The current which the electronic pump switch UNI allows to pass feeds a main energy store STO. The main energy store STO is usually embodied as an electrolytic capacitor. However, other types of capacitors are also possible. In principle, the dual form of energy storage with respect to the capacitor is also possible. In the dual case, the main energy STO is embodied as a coil. Owing to the lower costs and the better efficiency, a capacitor is preferred as the main energy store STO.

There are also embodiments of charge pumps having a plurality of so-called pump branches. In this case, a plurality or electronic pump switches UNI are connected in parallel. A plurality of pump nodes N1 arise as a result. For the mutual decoupling of the pump nodes, a diode is in each case connected between rectifier and pump node.

The main energy store STO makes its energy available to an inverter INV. The inverter INV generates an alternating quantity, usually an alternating voltage, which is fed to a block designated by MN and PN. MN designates the function of the block as a matching network. With regard to this function, the block MN/PN can be connected to at least one LED via a further rectifier GR and an inductance L. In this case, the rectifier GR ensures that current is made available to the at least one LED only in the direction in which it can be converted into light by the LED. The inductance L, which can also be realized by a transformer, serves for reducing the ripple of the current I_{LED} flowing through the at least one LED. PN designates the function of the block as a pump network. With regard to this function, the block MN/PN is connected to the pump node N1. The connecting line between the pump node N1 and the block MN/PN is provided with an arrow at both ends in FIG. 1. This is intended to indicate that energy flows alternately from the pump node N1 to the block MN/PN and back. The functions of the matching network and of the pump network are combined in the block MN/PN because embodiments of the invention are possible in which individual components can be assigned both to one function and to the other function.

A controller CONT is provided for controlling a desired operating quantity, said controller acting on the inverter INV by means of a manipulated variable. A parameter of the alternating quantity output by the inverter, for example the operating frequency and/or the pulse width, is thus altered in such a way that an alteration of the operating quantity is counteracted. The operating quantity is fed to an input of the controller CONT via the connection B1. The operating quantity is a quantity that determines the operation of the LED, for example the current I_{LED} through the LED. In FIG. 1, therefore, the connection B1 originates from the block for the LED. Instead of the current I_{LED} through the LED, for example the power converted in the LED can also form the operating quantity. These quantities do not have to be detected directly at the LED, but rather can also be taken from the block MN/PN.

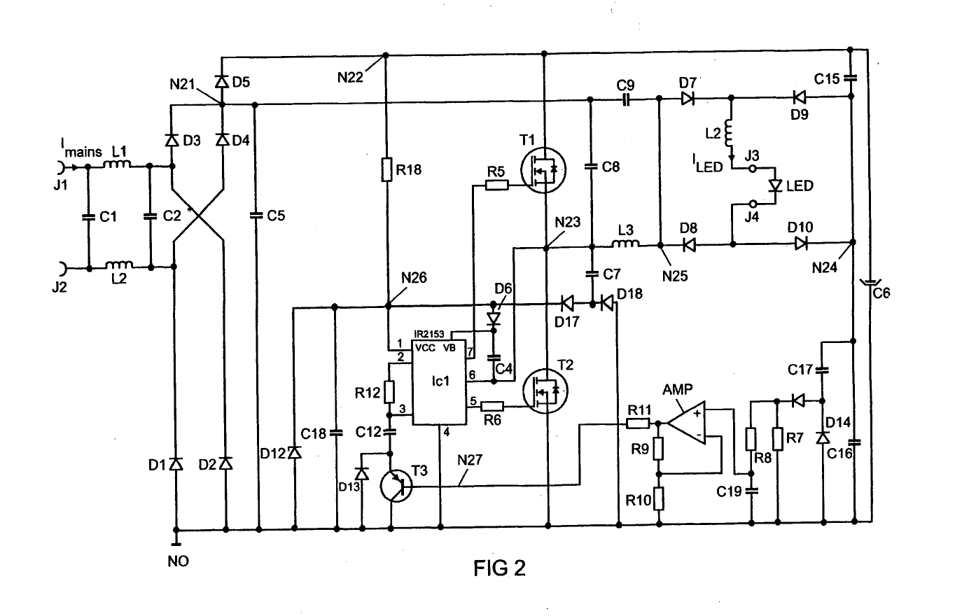

FIG. 2 illustrates an exemplary embodiment of a circuit arrangement according to the invention for operating at least one LED.

A mains voltage can be connected to the connections J1 and J2. Via a filter, comprising two capacitors C1, C2 and two coils L1, L2, the mains voltage is fed to a full-bridge rectifier, comprising the diodes D1, D2, D3, D4. The full-bridge rectifier provides the rectified mains voltage at its positive output, a node N21, with respect to a reference node N0. The node N21 is simultaneously a pump node. In this case, it should be taken into consideration that the diodes D1 to D4 used in the rectifier must be able to switch fast enough to follow the inverter frequency. If this is not the case, a fast diode can be connected between rectifier output and pump node.

From the pump node N21, an electronic pump switch, embodied as a diode D5, leads to the node N22. The main energy store, embodied as an electrolytic capacitor C6, is connected between N22 and N0. The capacitor C6 feeds the inverter, embodied as a half-bridge in the present case. However, other converter topologies, such as flyback converter or full-bridge, for example, can also be used.

The half-bridge illustrated in the exemplary embodiment in FIG. 2 comprises the series circuit formed by two half-bridge transistors T1 and T2 and the series circuit formed by two coupling capacitors C15 and C16. Both series circuits are connected in parallel with C6. A connecting node N23 of the half-bridge transistors and a connecting node N24 of the coupling capacitors C15, C16 form the inverter, at which a trapezoidal inverter voltage having an inverter frequency is present. An inductance L3 is connected between the node N23 and a node N25. A capacitor C8 acts as a trapezoidal capacitor. Energy for supplying an integrated circuit IC1, which will be discussed in greater detail further below, is tapped off via a capacitor C7. Since a trapezoidal voltage is present at the node N23 during operation of the inverter, a current flow is produced through the capacitor C7 during these times. In this case, the positive half-cycle is used via the diode D17 for supplying the circuit IC1 with current, while the negative half-cycle is conducted away via the diode D18 to the reference potential N0. The node N25 is connected to the pump node N21 via a first resonance capacitor C9. A second resonance capacitor C5 is connected between N21 and N0. C9 and C5 together with the inductor L3 form a resonant circuit. The inductor L3 interacts with C9 and C5 as a matching network which transforms an output impedance of the inverter into an impedance necessary for the operation of the at least one LED. By virtue of the connection of C9 and C5 to the pump node N21, however, the combination of L3, C9 and C5 acts not only as a resonant circuit and matching network, but simultaneously as a pump network. If the potential at N21 is lower than the instantaneous mains voltage, then the pump network L3, C9, C5 draws energy from the mains voltage. If the potential at N21 exceeds the voltage at the main energy store C6, then the energy taken up from the mains voltage is emitted to C6. The effect of the network L3, C9, C5 as a pump network can be adjusted through the choice of the ratio of the capacitances of C9 and C5. The larger the capacitance of C5 is chosen to be, the smaller the effect of the network L3, C5, C9 as a pump network. A further pump effect proceeds from the capacitor C8 connected between N23 and N21. C8, too, does not just act as a pump network but also fulfils, as mentioned, the task of a trapezoidal capacitor. Trapezoidal capacitors are generally known as a measure for switch load relief in inverters.

The matching network is followed by a second full-bridge rectifier, which is formed by the diodes D7, D8, D9 and D10. Said diodes ensure that the LED is fed a current having only one direction. A constant-current inductor L2 is arranged between the rectifier output and the connections J3, J4 for the at least one LED, said inductor providing for a reduction of the ripple of the current I_{LED} fed to the at least one LED. In the case of a desired potential isolation between a circuit arrangement according to the invention and the at least one LED, the constant-current inductor L2 can be realized by a transformer, wherein the second rectifier D7 to D10 is then arranged on the secondary side of the transformer.

Besides the illustrated variant with one pump branch, exemplary embodiments with two or more pump branches are readily conceivable, in which the pumped energy is shared between a plurality of components. A more cost-effective dimensioning of the components is thus possible. This also yields a degree of freedom in the design of the dependence of the pumped energy on operating parameters of the at least one LED.

The half-bridge transistors T1, T2 are designed as MOSFETs. Other electronic switches can also be used for this purpose. In the exemplary embodiment, an integrated circuit IC1 is provided for driving the gates of the transistors T1 and T2 via the resistors R5 and R6. In the present example, IC1 is a circuit from the company International Rectifier of the type IR2153. Alternative circuits to this type are also commercially available, for example an L6571 from the company STM. The circuit IR2153 contains a so-called high-side driver, which can also be used to drive the half-bridge transistor T1 even though it does not have a connection at the reference potential N0. A diode D6 and a capacitor C4 are necessary for this purpose. IC1 is supplied with operating voltage via the connection 1 of IC1. In FIG. 2, for this purpose the connection 1 is connected to a node N26, which is coupled to the node N22 via a resistor R18. The voltage at the node N26 is held at a predeterminable value by means of a zener diode D12 and provided to IC1 via a capacitor C18. As an alternative, by way of example, the component IC1 could be supplied by the rectified mains voltage via a resistor.

In addition to the driver circuits for the half-bridge transistors T1, T2, IC1 comprises an oscillator, the oscillation frequency of which can be set via the connections 2 and 3. The oscillation frequency of the oscillator corresponds to the inverter frequency. A frequency-determining resistor R12 is connected between the connections 2 and 3. The series circuit formed by a frequency-determining capacitor C12 and the emitter-collector path of a bipolar transistor T3 is connected between the connections 3 and N0. A diode D13 is connected in parallel with the emitter-collector path of T3 in order that the capacitor C12 can be charged and discharged. The inverter frequency can be set by a voltage between the base connection of T3 and N0 and thus forms a manipulated variable for a control loop. The base connection of T3 is connected to a manipulated variable node N24. T3, IC1 and the circuitry thereof can therefore be interpreted as a controller.

The functions of IC1 and the circuitry thereof can also be realized by any desired voltage- or current-controlled oscillator which realizes the driving of the half-bridge transistors by means of driver circuits.

The control loop in the exemplary embodiment detects the current I_{LED} through the LED as controlled variable. For this purpose, a quantity proportional to the current I_{LED} is fed via the capacitor C17 and the diodes D14 and D15 to a low-resistance measuring resistor R7. The voltage drop at R7 is therefore a measure of the current through the at least one LED. Via a low-pass filter for averaging, which is formed by a resistor R8 and a capacitor C19, the voltage drop passes to the input of a non-inverting measuring amplifier. The measuring amplifier is realized by an operational amplifier AMP and the resistors R9, R10 and R11 in a known manner. In the exemplary embodiment, a gain of the measuring amplifier of approximately 10 is set. For the case where the voltage drop at R7 has values which can be used directly as a manipulated variable, the measuring amplifier can be omitted or replaced by an impedance converter, such as an emitter follower for example.

The output of the measuring amplifier is connected to the node N27. This closes the control loop for controlling the current through the LED. By raising the oscillator frequency, a reduction of the current I_{LED} flowing through the at least one LED is obtained on account of an inductive load circuit.

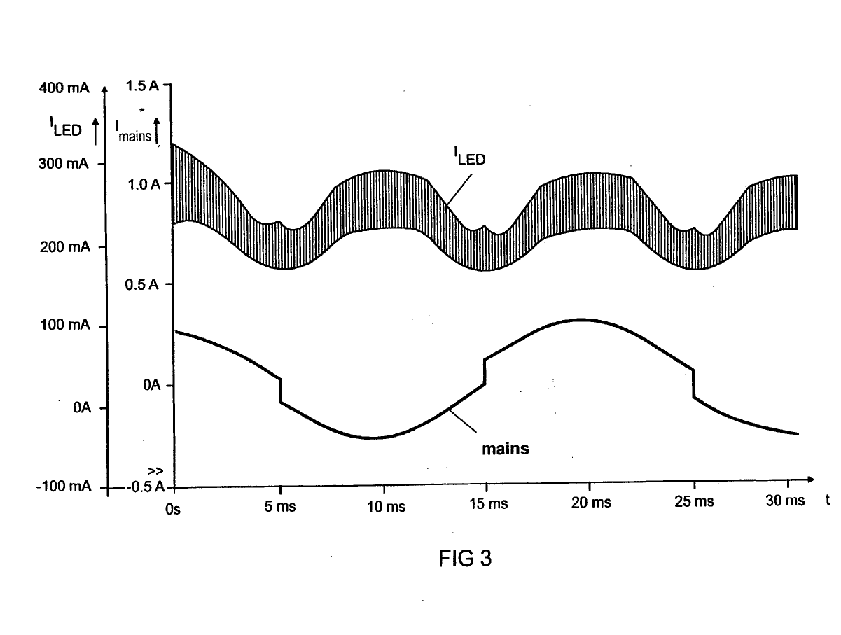

FIG. 3 shows, in a schematic arrangement, the temporal profile of the mains current Iₘₐᵢₙₛ and of the current I_{LED} through the at least one LED in a circuit arrangement in accordance with FIG. 2. The modulation—still discernible in FIG. 3—of the current I_{LED} flowing through the at least one LED—a 100 Hz modulation that is superposed by a high-frequency signal is involved in the present case—can be reduced further by an optimization of the control mentioned above, while the HF ripple can be reduced by enlarging the constant-current inductor L2.

1. A circuit arrangement for operating at least one LED, comprising:
a first and a second mains connection (J) for connecting a mains voltage;
a first rectifier (FR), the rectifier input of which is coupled to the mains connections (J) and at the rectifier output of which the rectified mains voltage can be provided;
an electronic pump switch (UNI) which is coupled to the rectifier output, as a result of which a pump node (N1) is defined;
a main energy store (STO), which is coupled to that side of the electronic pump switch (UNI) which is remote from the rectifier output;
an inverter (INV), which is coupled to the main energy store (STO) in order to be supplied with energy from the latter, wherein the inverter (INV) is designed to provide at its inverter output an inverter voltage having an inverter frequency;
a pump network (PN), via which the inverter output is coupled to the pump node (N1);
a matching network (MN), via which the inverter output is coupled to the connection terminals (J) for the at least one LED, wherein the matching network (MN) has a resonant circuit having a natural frequency.

2. The circuit arrangement as claimed in claim 1,
characterized
in that it furthermore comprises:
a second rectifier (GR), in particular a full-bridge rectifier (D7, D8, D9, D10), which is coupled between the matching network (L3, C9) and the connection terminals (J3, J4) for the at least one LED.

3. The circuit arrangement as claimed in claim 2,
characterized
in that the circuit arrangement furthermore has at least one coupling capacitor (C15; C16), and in that the matching network (MN) comprises an LC series resonant circuit (L3, C9), wherein the rectifier input of the second rectifier (D7, D8, D9, D10) is coupled to the high point of the LC series resonant circuit, on the one hand, and to the at least one coupling capacitor (C15; C16), on the other hand.

4. The circuit arrangement as claimed in claim 1,
characterized
in that a transformer is coupled between the matching network and the connection terminals for the at least one LED.

5. The circuit arrangement as claimed in claim 4,
characterized
in that the primary side of the transformer is coupled to the matching network and the secondary side of the transformer is coupled to the connection terminals for the at least one LED, wherein a second rectifier, in particular a full-bridge rectifier, is coupled between the secondary side of the transformer and the connection terminals for the at least one LED.

6. The circuit arrangement as claimed in claim 2,
characterized
in that an inductance (L2) is arranged in series with the rectifier output of the second rectifier (D7, D8, D9, D10) and with the connection terminals (J3, J4) for the at least one LED.

7. The circuit arrangement as claimed in claim 1,
characterized
in that it furthermore comprises:
a controller (CONT), at the controller output of which an actuating signal can be provided, wherein the controller output is coupled to the inverter (INV) in such a way that the actuating signal influences the inverter frequency.

8. The circuit arrangement as claimed in claim 7,
characterized
in that the controller input is coupled to a device (B1) for measuring a quantity that is proportional to the current through the at least one LED.

9. The circuit arrangement as claimed in claim 1,
characterized
in that the circuit arrangement is designed to operate a plurality of LEDs connected in series between the output terminals (J3, J4) of the circuit arrangement.

10. An operating method for operating at least one LED at a circuit arrangement comprising a first and a second mains connection (J) for connecting a mains voltage, a first rectifier (FR), the rectifier input of which is coupled to the mains connections (J) and at the rectifier output of which the rectified mains voltage can be provided, an electronic pump switch (UNI) which is coupled to the rectifier output, as a result of which a pump node (N1) is defined, a main energy store (STO), which is coupled to that side of the electronic pump switch (UNI) which is remote from the rectifier output, an inverter (INV), which is coupled to the main energy store (STO) in order to be supplied with energy from the latter, wherein the inverter (INV) is designed to provide at its inverter output an inverter voltage having an inverter frequency, a pump network (PN), via which the inverter output is coupled to the pump node (N1), and a matching network (MN), via which the inverter output is coupled to the connection terminals (J) for the at least one LED, wherein the matching network (MN) has a resonant circuit having a natural frequency.

11. The circuit arrangement as claimed in claim 3,
characterized
in that an inductance (L2) is arranged in series with the rectifier output of the second rectifier (D7, D8, D9, D10) and with the connection terminals (J3, J4) for the at least one LED.

12. The circuit arrangement as claimed in claim 5,
characterized
in that an inductance (L2) is arranged in series with the rectifier output of the second rectifier (D7, D8, D9, D10) and with the connection terminals (J3, J4) for the at least one LED.

13. The circuit arrangement as claimed in claim 2,
characterized
in that it furthermore comprises:
a controller (CONT), at the controller output of which an actuating signal can be provided, wherein the controller output is coupled to the inverter (INV) in such a way that the actuating signal influences the inverter frequency.

14. The circuit arrangement as claimed in claim 2,
characterized
in that the circuit arrangement is designed to operate a plurality of LEDs connected in series between the output terminals (J3, J4) of the circuit arrangement.
